(19) United States
(12) Patent Application Publication
(10) Pub. No.: US 2018/0355795 A1
(43) Pub. Date: Dec. 13, 2018

(54) ROTATING DETONATION COMBUSTOR WITH FLUID DIODE STRUCTURE

(71) Applicant: General Electric Company, Schenectady, NY (US)

(72) Inventors: Sibtosh Pal, Mason, OH (US); Joseph Zelina, Waynesville, OH (US); Arthur Wesley Johnson, Cincinnati, OH (US); Clayton Stuart Cooper, Loveland, OH (US); Steven Clayton Vise, Loveland, OH (US)

(21) Appl. No.: 15/618,575

(22) Filed: Jun. 9, 2017

(51) Int. Cl. F02C 5/02; F23R 3/28; F23R 3/42

(52) U.S. Cl. CPC F02C 5/02; F05D 2240/35; F23R 3/42; F23R 3/28

(57) ABSTRACT

The present disclosure is directed to a rotating detonation combustion system for a propulsion system, the rotating detonation combustion system defining a radial direction, a circumferential direction, and a longitudinal centerline in common with the propulsion system extended along a longitudinal direction. The rotating detonation combustion system includes an outer wall and an inner wall together defining at least in part a combustion chamber and a combustion chamber inlet; a nozzle located at the combustion chamber inlet defined by a nozzle wall, the nozzle defining a lengthwise direction and extending between a nozzle inlet and a nozzle outlet along the lengthwise direction, the nozzle inlet configured to receive a flow of oxidizer, the nozzle further defining a throat between the nozzle inlet and nozzle outlet, and wherein the nozzle defines a converging-diverging nozzle, and wherein a diverging section of the nozzle wall defines a fluid diode; and a fuel injection port defining a fuel outlet located between the nozzle inlet and the nozzle outlet for providing fuel to the flow of oxidizer received through the nozzle inlet.

### FIELD

The present subject matter relates generally to a system of continuous detonation in a propulsion system.

### BACKGROUND

Many propulsion systems, such as gas turbine engines, are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such propulsion systems generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in either a continuous or pulsed mode. The pulsed mode design involves one or more detonation tubes, whereas the continuous mode is based on a geometry, typically an annulus, within which single or multiple detonation waves spin. For both types of modes, high energy ignition detonates a fuel/air mixture that transitions into a detonation wave (i.e., a fast moving shock wave closely coupled to the reaction zone). The detonation wave travels in a Mach number range greater than the speed of sound (e.g., Mach 4 to 8) with respect to the speed of sound of the reactants. The products of combustion follow the detonation wave at the speed of sound relative to the detonation wave and at significantly elevated pressure. Such combustion products may then exit through a nozzle to produce thrust or rotate a turbine.

With various rotating detonation systems, the task of preventing backflow into the lower pressure regions upstream of the rotating detonation has been addressed by providing a steep pressure drop into the combustion chamber. However, such may reduce the efficiency benefits of the rotating detonation combustion system. Accordingly, a rotating detonation combustion system capable of addressing these concerns without providing for a steep pressure drop into the combustion chamber would be useful. Furthermore, there is a need for rotating detonation combustion systems that provide low pressure drop operation.

### BRIEF DESCRIPTION

Aspects and advantages of the invention will be set forth in part in the following description, or may be obvious from the description, or may be learned through practice of the invention.

The present disclosure is directed to a rotating detonation combustion system for a propulsion system, the rotating detonation combustion system defining a radial direction, a circumferential direction, and a longitudinal centerline in common with the propulsion system extended along a longitudinal direction. The rotating detonation combustion system includes an outer wall and an inner wall together defining at least in part a combustion chamber and a combustion chamber inlet; a nozzle located at the combustion chamber inlet defined by a nozzle wall, the nozzle defining a lengthwise direction and extending between a nozzle inlet and a nozzle outlet along the lengthwise direction, the nozzle inlet configured to receive a flow of oxidizer, the nozzle further defining a throat between the nozzle inlet and nozzle outlet, and wherein the nozzle defines a converging-diverging nozzle, and wherein a diverging section of the nozzle wall defines a fluid diode; and a fuel injection port defining a fuel outlet located between the nozzle inlet and the nozzle outlet for providing fuel to the flow of oxidizer received through the nozzle inlet.

In various embodiments, the fluid diode defines a waveform configured to dampen upstream propagation of pressure waves from detonation of a fuel-oxidizer mixture. In one embodiment, the waveform is a sawtooth waveform, a square waveform, a triangle waveform, a sine waveform, or combinations thereof. In various embodiments, the waveform is a sawtooth waveform, a triangle waveform, or combinations thereof, and wherein the waveform defines a waveform angle, and wherein the waveform angle extends between approximately zero degrees and approximately 90 degrees relative to the longitudinal centerline. In still another embodiment, the waveform angle extends between approximately 45 degrees and approximately 90 degrees relative to the longitudinal centerline.

In one embodiment, the fluid diode defines a honeycomb pattern.

In another embodiment, the fluid diode is asymmetric along at least one of the outer wall and the inner wall along the longitudinal direction.

In various embodiments, a converging section of at least one of the outer wall and the inner wall of the nozzle defines a fluid diode. In one embodiment, the waveform is a sawtooth waveform, a triangle waveform, or combinations thereof, and wherein the waveform defines a waveform angle, and wherein the waveform angle extends between approximately zero degrees and approximately 90 degrees relative to the longitudinal centerline.

In another embodiment, the diverging section of the nozzle is defined on the outer wall and the inner wall between the throat and the nozzle outlet of the nozzle, and wherein one or more of the outer wall and the inner wall defines the fluid diode.

In one embodiment, a converging section is defined on the nozzle wall between the nozzle inlet and the throat of the nozzle, and wherein the fluid diode is defined on the converging section of the nozzle wall.

In various embodiments, the nozzle is configured as one of a plurality of nozzles arranged in an array along the circumferential direction. In one embodiment, the plurality of nozzles includes a plurality of arrays of nozzles disposed in adjacent arrangement along the radial direction, in which each array is configured to at least one operating condition of the propulsion system.

In another embodiment, the outer wall and the inner wall are annular and are each generally concentric to the longitudinal centerline, and wherein the outer wall and the inner wall together define the nozzle wall as an annular structure concentric to the longitudinal centerline. In still another embodiment, the fluid diode is asymmetric along at least one of the outer wall and the inner wall along the circumferential direction.

In still various embodiments, the rotating detonation combustion system further includes an annular intermediate wall disposed along the radial direction between the outer wall and the inner wall and generally concentric to the longitudinal centerline, wherein the outer wall, the intermediate wall, and the inner wall together define a plurality of annular nozzles generally concentric to the longitudinal centerline, and wherein each nozzle defines the throat between the nozzle inlet and the nozzle outlet. In one embodiment, the annular intermediate wall at least partially defines a diverging section of the nozzle, and wherein the diverging section defines a fluid diode. In another embodiment, the plurality of annular nozzles is disposed in adjacent arrangement along the radial direction and generally concentric to the longitudinal centerline.

In one embodiment, the nozzle defines a nozzle length, wherein the fuel outlet of the fuel injection port is positioned at the throat of the nozzle or within a buffer distance from the throat of the nozzle along the lengthwise direction, wherein the buffer distance is ten percent of the nozzle length. In another embodiment, the fluid diode is defined at least downstream of the buffer distance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a gas turbine engine in accordance with an exemplary embodiment of the present disclosure;

FIG. 2 is a side, cross-sectional view of a rotating detonation combustion system in accordance with an exemplary embodiment of the present disclosure;

FIG. 3 is a perspective view of a combustion chamber of the exemplary rotating detonation combustion system of FIG. 2;

FIG. 4 is a close-up, side, cross-sectional view of a nozzle of the exemplary rotating detonation combustion system of FIG. 2 in accordance with an exemplary embodiment of the present disclosure;

FIG. 5 is a close-up, side, cross-sectional view of another exemplary nozzle of the rotating detonation combustion system of FIG. 2 in accordance with an exemplary embodiment of the present disclosure;

FIG. 6 is a close-up, side, cross-sectional view of yet another exemplary nozzle of the rotating detonation combustion system of FIG. 2 in accordance with an exemplary embodiment of the present disclosure;

FIG. 7 is a close-up, side, cross-sectional view of still another exemplary nozzle of the rotating detonation combustion system of FIG. 2 in accordance with an exemplary embodiment of the present disclosure;

FIG. 8 is a close-up, side, cross-sectional view of yet still another exemplary nozzle of the rotating detonation combustion system of FIG. 2 in accordance with an exemplary embodiment of the present disclosure;

FIG. 9 is a close-up, side, cross-sectional view of another exemplary nozzle of the rotating detonation combustion system of FIG. 2 in accordance with an exemplary embodiment of the present disclosure;

FIG. 10 is an exemplary structure of the nozzle of the rotating detonation combustion system of FIG. 2 in accordance with an exemplary embodiment of the present disclosure;

FIG. 11 is an axial view of an exemplary embodiment of the rotating detonation combustion system of FIG. 2; and

FIG. 12 is an axial view of another exemplary embodiment of the rotating detonation combustion system of FIG. 2.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a propulsion system or vehicle, and refer to the normal operational attitude of the propulsion system or vehicle. For example, with regard to a propulsion system, forward refers to a position closer to a propulsion system inlet and aft refers to a position closer to a propulsion system nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

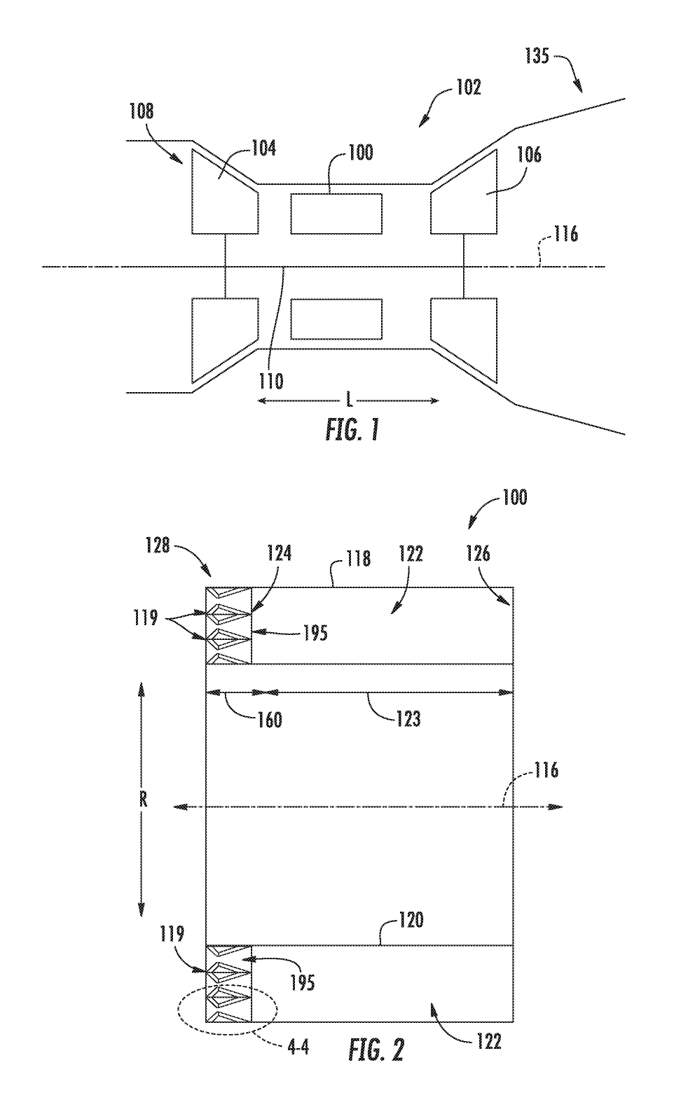

Referring now to the figures, FIG. 1 depicts a propulsion system including a rotating detonation combustion system 100 (an “RDC system”) in accordance with an exemplary embodiment of the present disclosure. For the embodiment of FIG. 1, the engine is generally configured as a propulsion system 102. More specifically, the propulsion system 102 generally includes a compressor section 104 and a turbine section 106, with the RDC system 100 located downstream of the compressor section 104 and upstream of the turbine section 106. During operation, an airflow may be provided to an inlet 108 of the compressor section 104, wherein such airflow is compressed through one or more compressors, each of which may include one or more alternating stages of compressor rotor blades and compressor stator vanes. As will be discussed in greater detail below, compressed air from the compressor section 104 may then be provided to the RDC system 100, wherein the compressed air may be mixed with a fuel and detonated to generate combustion products. The combustion products may then flow to the turbine section 106 wherein one or more turbines may extract kinetic/rotational energy from the combustion products. As with the compressor(s) within the compressor section 104, each of the turbine(s) within the turbine section 106 may include one or more alternating stages of turbine rotor blades and turbine stator vanes. The combustion products may then flow from the turbine section 106 through, e.g., an exhaust nozzle 135 to generate thrust for the propulsion system 102.

As will be appreciated, rotation of the turbine(s) within the turbine section 106, generated by the combustion products, is transferred through one or more shafts or spools 110 to drive the compressor(s) within the compressor section 104. In various embodiments, the compressor section 104 may further define a fan section, such as for a turbofan engine configuration, such as to propel air across a bypass flowpath outside of the RDC system 100 and turbine section 106.

It will be appreciated that the propulsion system 102 depicted schematically in FIG. 1 is provided by way of example only. In certain exemplary embodiments, the propulsion system 102 may include any suitable number of compressors within the compressor section 104, any suitable number of turbines within the turbine section 106, and further may include any number of shafts or spools 110 appropriate for mechanically linking the compressor(s), turbine(s), and/or fans. Similarly, in other exemplary embodiments, the propulsion system 102 may include any suitable fan section, with a fan thereof being driven by the turbine section 106 in any suitable manner. For example, in certain embodiments, the fan may be directly linked to a turbine within the turbine section 106, or alternatively, may be driven by a turbine within the turbine section 106 across a reduction gearbox. Additionally, the fan may be a variable pitch fan, a fixed pitch fan, a ducted fan (i.e., the propulsion system 102 may include an outer nacelle surrounding the fan section), an un-ducted fan, or may have any other suitable configuration.

Moreover, it should also be appreciated that the RDC system 100 may further be incorporated into any other suitable aeronautical propulsion system, such as a turboshaft engine, a turboprop engine, a turbojet engine, a ramjet engine, a scramjet engine, etc. Further, in certain embodiments, the RDC system 100 may be incorporated into a non-aeronautical propulsion system, such as a land-based power-generating propulsion system, an aero-derivative propulsion system, etc. Further, still, in certain embodiments, the RDC system 100 may be incorporated into any other suitable propulsion system, such as a rocket or missile engine. With one or more of the latter embodiments, the propulsion system may not include a compressor section 104 or a turbine section 106, and instead may simply include a nozzle 140 with the combustion products flowing therethrough to generate thrust.

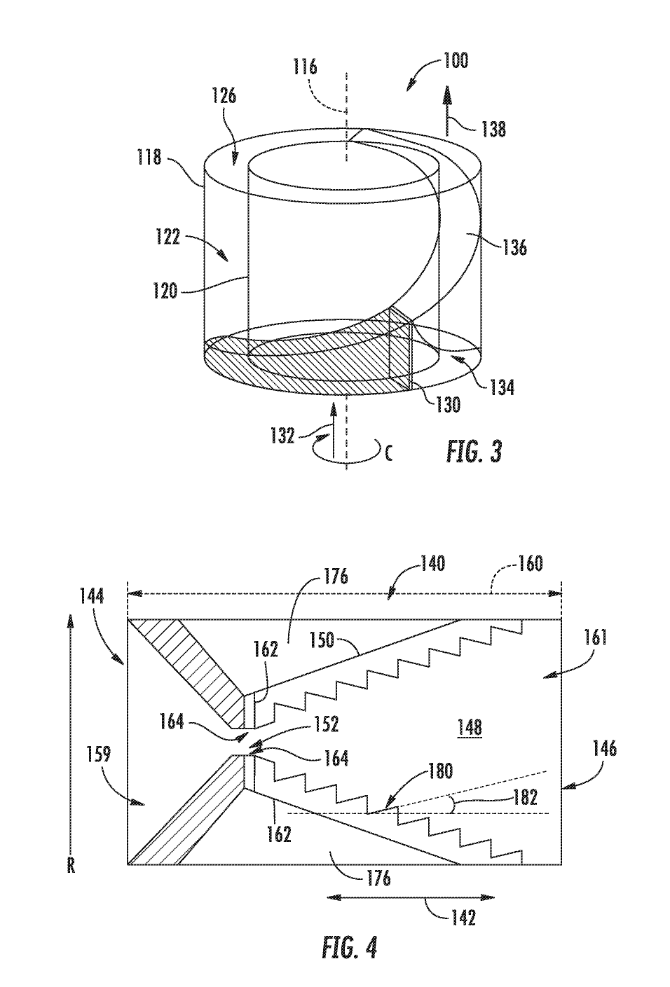

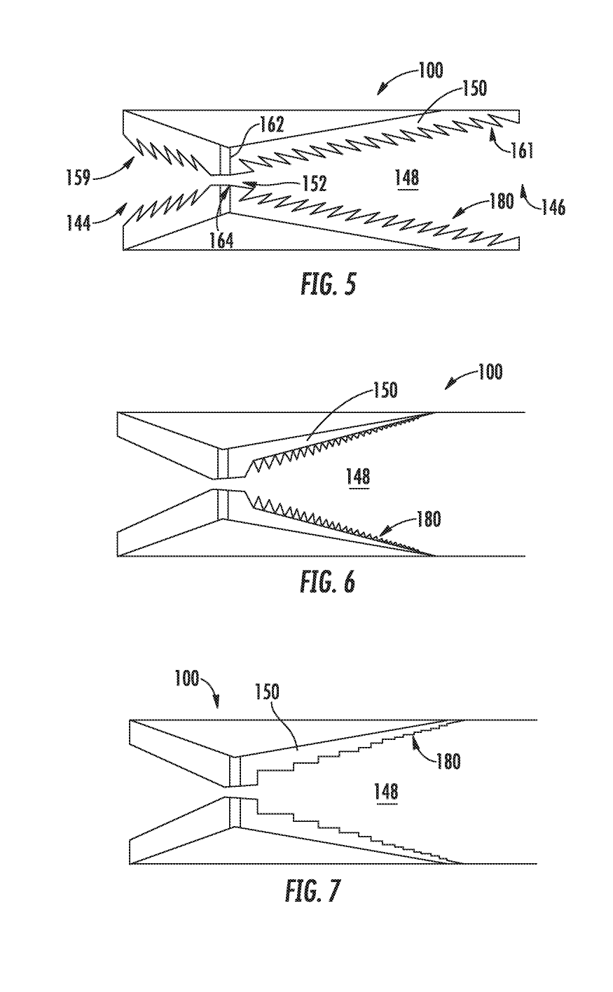

Referring now to FIG. 2, a side, schematic view is provided of an exemplary RDC system 100 as may be incorporated into the exemplary embodiment of FIG. 1. As shown, the RDC system 100 generally defines a longitudinal centerline 116 common to the propulsion system 102, a radial direction R relative to the longitudinal centerline 116, and a circumferential direction C relative to the longitudinal centerline 116 (see, e.g., FIGS. 3 and 5), and a longitudinal direction L (shown in FIG. 1).

The RDC system 100 generally includes an outer wall 118 and an inner wall 120 spaced from one another along the radial direction R. The outer wall 118 and the inner wall 120 together define in part a combustion chamber 122, a combustion chamber inlet 124, and a combustion chamber outlet 126. The combustion chamber 122 defines a combustion chamber length 123 along the longitudinal centerline 116.

Further, the RDC system 100 includes a nozzle assembly 128 located at the combustion chamber inlet 124. The nozzle assembly 128 provides a flow mixture of oxidizer and fuel to the combustion chamber 122, wherein such mixture is combusted/detonated to generate the combustion products therein, and more specifically a detonation wave 130 as will be explained in greater detail below. The combustion products exit through the combustion chamber outlet 126.

In one embodiment, the outer wall 118 and the inner wall 120 are each generally annular and generally concentric around the longitudinal centerline 116. The nozzle assembly 128 located at the combustion chamber inlet 124 is generally annular and generally concentric to the longitudinal centerline 116. The nozzle assembly 128 provides a flow mixture of oxidizer and fuel to the combustion chamber 122, wherein such mixture is combusted/detonated to generate the combustion products therein, and more specifically a detonation wave 130 as will be explained in greater detail below. The combustion products exit through the combustion chamber outlet 126. Although the combustion chamber 122 is depicted as a single combustion chamber, in other exemplary embodiments of the present disclosure, the RDC system 100 (through the inner and outer walls 120, 118 and/or intermediate walls 119 depicted in FIG. 4) may include multiple combustion chambers, such as generally provided in FIG. 12.

Referring briefly to FIG. 3, providing a perspective view of the combustion chamber 122 (without the nozzle assembly 128), it will be appreciated that the RDC system 100 generates the detonation wave 130 during operation. The detonation wave 130 travels in the circumferential direction C of the RDC system 100 consuming an incoming fuel/oxidizer mixture 132 and providing a high pressure region 134 within an expansion region 136 of the combustion. A burned fuel/oxidizer mixture 138 (i.e., combustion products) exits the combustion chamber 122 and is exhausted.

More particularly, it will be appreciated that the RDC system 100 is of a detonation-type combustor, deriving energy from the continuous wave 130 of detonation. For a detonation combustor, such as the RDC system 100 disclosed herein, the combustion of the fuel/oxidizer mixture 132 is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh mixture 132, increasing such mixture 132 above a self-ignition point. On the other side, energy released by the combustion contributes to the propagation of the detonation shockwave 130. Further, with continuous detonation, the detonation wave 130 propagates around the combustion chamber 122 in a continuous manner, operating at a relatively high frequency. Additionally, the detonation wave 130 may be such that an average pressure inside the combustion chamber 122 is higher than an average pressure within typical combustion systems (i.e., deflagration combustion systems).

Accordingly, the region 134 behind the detonation wave 130 has very high pressures. As will be appreciated from the discussion below, the nozzle assembly 128 of the RDC system 100 is designed to prevent the high pressures within the region 134 behind the detonation wave 130 from flowing in an upstream direction, i.e., into the incoming flow of the fuel/oxidizer mixture 132.

Referring back to FIG. 2, and now also to FIG. 4, the nozzle assembly 128 includes a plurality of nozzles 140 disposed in adjacent arrangement along the radial direction R. The nozzle 140 extends along the lengthwise direction 142 between a nozzle inlet 144 and a nozzle outlet 146, and further defines a nozzle flowpath 148 extending from the nozzle inlet 144 to the nozzle outlet 146. In various embodiments, the nozzle 140 includes a nozzle wall 150 defining the nozzle flowpath 148, such as shown in FIGS. 2 and 4.

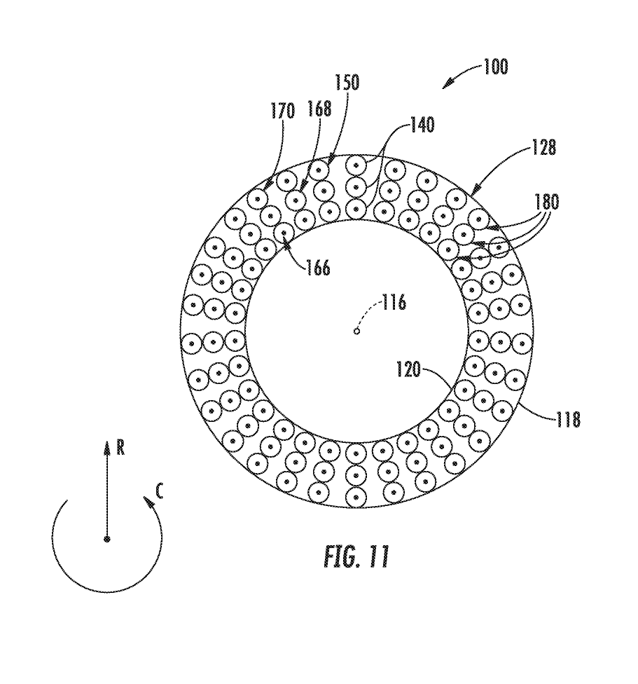

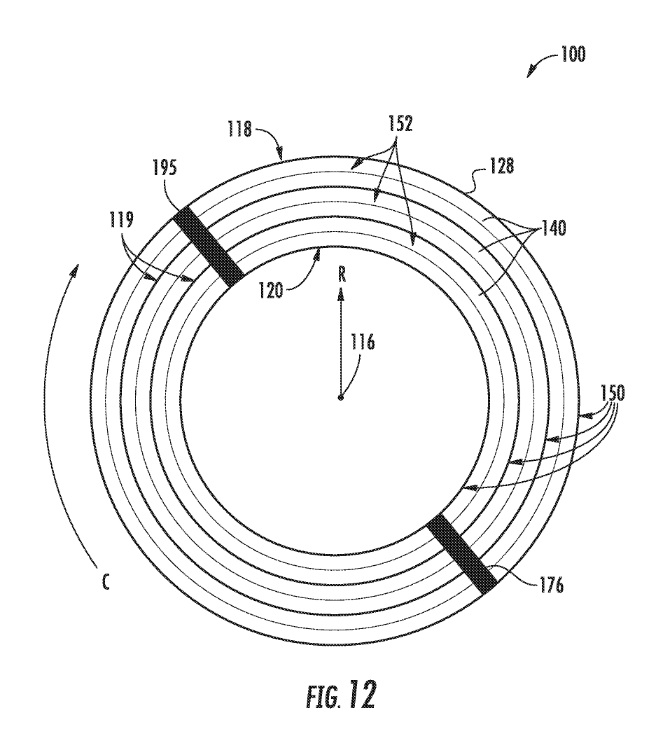

In one embodiment, such as generally provided in FIG. 11, the plurality of nozzles 140 are each defined by a plurality of the nozzle wall 150 defining the nozzle flowpath 148. For example, such as generally provided in FIG. 11, each nozzle 140 is disposed in adjacent arrangement along the radial direction R and the circumferential direction C within the RDC system 100. The exemplary embodiment generally provided in FIG. 11 includes three radial arrays of nozzles 140 in which each array includes a plurality of nozzles 140 in adjacent arrangement along the circumferential direction C around the longitudinal centerline 116.

In another embodiment, such as generally provided in FIG. 12, the nozzle 140 defines the nozzle wall 150 as an annular structure generally concentric to the longitudinal centerline 116 and defining the nozzle flowpath 148. In various embodiments, the nozzle wall 150 is a continuous nozzle wall extending from the nozzle inlet 144 to the nozzle outlet 146. The nozzle wall 150 generally includes at least a portion of the outer wall 118 and the inner wall 120 of the RDC system 100. In various embodiments, the nozzle wall 150 may further include one or more intermediate walls 119 therebetween along the radial direction R.

Referring to FIGS. 2-12, the nozzle wall 150 may have any suitable configuration. In various embodiments, the nozzle 140 defines a converging-diverging nozzle, in which the nozzle wall 150 decreases the nozzle flowpath area from approximately the nozzle inlet 144 to approximately a throat 152 between the nozzle inlet 144 and nozzle outlet 146, and in which the nozzle wall 150 increases the nozzle flowpath area from approximately the throat 152 to approximately the nozzle outlet 146.

Referring particularly to the close up, side, cross-sectional view of the nozzle 140 depicted in FIG. 4 (identified by Circle 4-4 in FIG. 2), the nozzle 140 is located at the combustion chamber inlet 124 and defines a lengthwise direction 142. In certain exemplary embodiments, the lengthwise direction 142 may extend parallel to the longitudinal centerline 116 of the combustor 100. Alternatively, however, in other embodiments, the combustor 100 may be configured such that the lengthwise direction 142 of the nozzles 140 defines an angle with the longitudinal centerline, such as an angle between two degrees and forty-five degrees, such as between five degrees and thirty degrees, in the positive or negative relative to the longitudinal centerline (e.g., converging or diverging).

Referring still to FIG. 4, in various embodiments, the nozzle wall 150 defines a fluid diode structure 180 on at least the diverging section 161 of the nozzle 140. The fluid diode structure 180 may isolate, or significantly isolate, the combustion chamber 122 (shown in FIG. 2), including the nozzle flowpath 148, from high pressure waves propagating toward the upstream end of the RDC system 100 that result from combustion of the fuel-oxidizer in the combustion chamber 122. In one embodiment, such as shown in FIG. 11, the fluid diode structure 180 is defined on the nozzle wall 150 of one or more of each nozzle 140. For example, each nozzle 140 may define the fluid diode structure 180. As further discussed below, each array of nozzles 140, or each nozzle 140 individually, may define a different fluid diode structure 180 from another nozzle 140.

In still other embodiments, such as generally provided in FIG. 12, the fluid diode structure 180 is defined on the nozzle wall 150, such as on the outer wall 118, the inner wall 120, or both.

In various embodiments, such as generally provided in FIGS. 4-9, the fluid diode 180 defines a waveform structure. The waveform structure of the fluid diode 180 is generally configured to dampen upstream propagation of pressure waves from detonation of a fuel-oxidizer mixture. In one embodiment, such as shown in FIG. 4, the fluid diode 180 defines a sawtooth waveform along at least one of the outer wall 118 and the inner wall 120 of the nozzle wall 150. The sawtooth waveform may define a plurality of edges disposed generally toward the downstream end or the combustion chamber 122. For example, in various embodiments, the waveform defines an angle 182 relative to the longitudinal centerline 116. In one embodiment, the waveform defined by the fluid diode 180 defines an acute angle 182 relative to the longitudinal centerline 116 such that a tip, edge, or rounded-end of the waveform is pointed generally toward the downstream or aft direction toward the combustion chamber 122. More specifically, in one embodiment the fluid diode 180 defines a sawtooth waveform, a triangle waveform, or combination thereof, in which the waveform angle 182 extends between approximately zero degrees and approximately 90 degrees relative to the longitudinal centerline 116. In yet another embodiment, the waveform angle 116 extends between approximately 45 degrees and approximately 90 degrees relative to the longitudinal centerline 116.

Referring still to the various embodiments of fluid diodes 180 generally provided in FIGS. 4-9, the embodiment shown in FIG. 5 is configured substantially similarly to the embodiment shown in FIG. 4. However, in FIG. 5, the fluid diode 180 is further defined on at least one of the outer wall 118 and the inner wall 120 of the nozzle wall 150 upstream of the throat 152 of the nozzle 140. For example, the fluid diode 180 is defined on a converging section 159 of the nozzle 140 between the nozzle inlet 144 and the throat 152. In the embodiment shown in FIG. 5, the fluid diode 180 at the converging section 159 defines a sawtooth waveform. However, in other embodiments, such as generally provided in FIGS. 6-9, the converging section 159 may define any other waveform at the converging section 159, the diverging section 161, or any combination thereof along the outer wall 118, the inner wall 120, or the intermediate wall 119 (shown in FIG. 2).

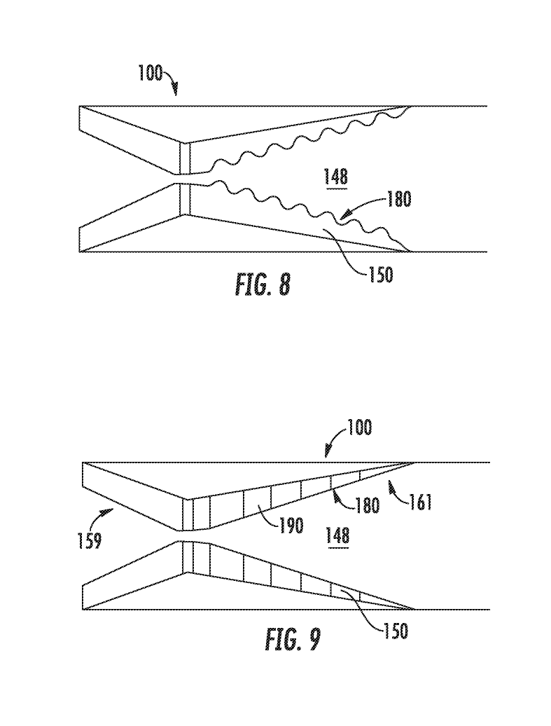

Referring now to FIGS. 6-9, the RDC 100 may be configured substantially similarly as described in regard to FIGS. 1-5. In FIG. 6, the fluid diode 180 may define a triangle waveform. In FIG. 7, the fluid diode 180 may define a generally square or rectangular waveform. In FIG. 8, the fluid diode 180 may define a generally sinusoidal waveform or other contoured waveform. It should be further appreciated that any combination of waveforms may be employed on the outer wall 118, the inner wall 120, the intermediate wall 119 (shown in FIG. 2), at the diverging section 161, the converging section 159, or combinations thereof.

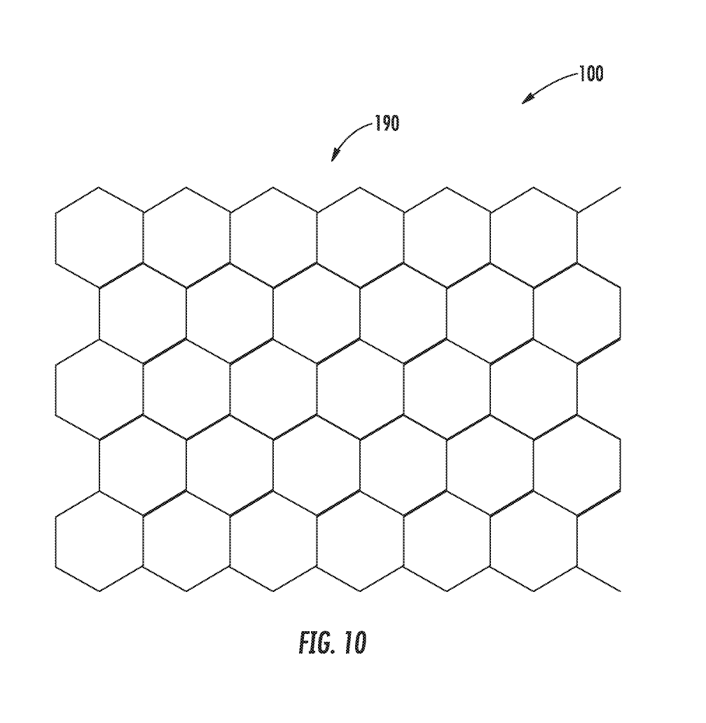

Referring now to FIGS. 9-10, the fluid diode 180 of the RDC 100 may define a honeycomb structure 190 along the outer wall 118, the inner wall 120, the intermediate wall 119 (shown in FIG. 2), or any combination thereof along the diverging section 161, the converging section 159, or both. The honeycomb structure 190, such as generally provided in the radial view of the nozzle wall 150 in FIG. 10, may define a plurality of generally circular or polygonal cross sectional walls recessed into the nozzle wall 150 to generally isolate or mitigate propagation of high pressure waves or oscillations from combustion of the fuel-oxidizer mix in the combustion chamber 122. In various embodiments, the fluid diode 180 may be disposed generally symmetrically along the nozzle wall 150.

Referring back to FIG. 4, the nozzle inlet 144 is configured to receive a flow of oxidizer during operation of the RDC system 100 and provide such flow oxidizer through/along the nozzle flowpath 148. The flow of oxidizer may be a flow of air, oxygen, etc. More specifically, when the nozzle 140 of the nozzle assembly 128 is incorporated into the RDC system 100 of the propulsion system 102 of FIG. 1, the flow oxidizer will be a flow of compressed air from the compressor section 104.

The nozzle 140, or, more specifically, the nozzle wall 150, further defines the throat 152 between the nozzle inlet 144 and the nozzle outlet 146, i.e., downstream of the nozzle inlet 144 and upstream of the nozzle outlet 146. As used herein, the term “throat”, with respect to the nozzle 140, refers to the point within the nozzle flowpath 148 having the smallest cross-sectional area. Additionally, as used herein, the term “cross-sectional area”, such as a cross-sectional area 156 of the throat 152 (described in more detail below), refers to an area within the nozzle flowpath 148 at a cross-section measured along the radial direction R at the respective location along the nozzle flowpath 148.

In various embodiments, the nozzle 140 may be referred to as a converging-diverging nozzle. Further, for the embodiment depicted, the throat 152 is positioned closer to the nozzle inlet 144 than the nozzle outlet 146 along the lengthwise direction 142 of the nozzle 140. More specifically, as is depicted, the nozzle 140 defines a length 160 along the lengthwise direction 142. The throat 152 for the exemplary nozzle 140 depicted is positioned in a forward, or upstream, half of the length 160 of the nozzle 140. More specifically, still, for the embodiment depicted the throat 152 of the exemplary nozzle 140 depicted is positioned approximately between the forward ten percent and fifty percent of the length 160 of the nozzle 140 along the lengthwise direction 142, such as approximately between the forward twenty percent and forty percent of the length 160 of the nozzle 140 along the lengthwise direction 142.

A nozzle 140 having such a configuration may provide for a substantially subsonic flow through the nozzle flowpath 148. For example, the flow from the nozzle inlet 144 to the throat 152 (i.e., a converging section 159 of the nozzle 140) may define an airflow speed below Mach 1. The flow through the throat 152 may define an airflow speed less than Mach 1, but approaching Mach 1, such as within about ten percent of Mach 1, such as within about five percent of Mach 1. Additionally, the flow from the throat 152 to the nozzle outlet 146 (i.e., a diverging section 161 of the nozzle 140) may again define an airflow speed below Mach 1 and less than the airflow speed through the throat 152. In other embodiments, the airflow speed may be Mach 1 downstream of the throat 152. For example, a small region downstream of the throat 152 may define an airflow speed at or above Mach 1 before defining a weak normal shock to less than Mach 1.

As is also depicted, the RDC system 100 further includes a fuel injection port 162. The fuel injection port 162 defines a fuel outlet 164 in fluid communication with the nozzle flowpath 148 and located between the nozzle inlet 144 and the nozzle outlet 146 for providing fuel to the flow of oxidizer received through the nozzle inlet 144. More specifically, in various embodiments, the fuel outlet 164 of the fuel injection port 162 is positioned within a buffer distance from the throat 152 of the nozzle 140 along the lengthwise direction 142 of the nozzle 140 (with the buffer distance being a distance equal to ten percent of the length 160 of the nozzle 140 along the lengthwise direction 142). More particularly, for the embodiment depicted, the fuel outlet 164 of the fuel injection port 162 is positioned at the throat 152 of the nozzle 140, or downstream of the throat 152 of the nozzle 140 along the lengthwise direction 142 of the nozzle 140. More specifically still, for the embodiment depicted, the fuel outlet 164 of the fuel injection port 162 is positioned at the throat 152 of the nozzle 140. It will be appreciated, that as used herein, the term “at the throat of the nozzle” refers to including at least a portion of the component or feature positioned at a location within the nozzle flowpath 148 defining the smallest cross-sectional area (i.e., defining the throat 152). Notably, for the embodiment of FIG. 4, the throat 152 of the exemplary nozzle 140 depicted is not a single point along the lengthwise direction 142, and instead extends for a distance along the lengthwise direction 142. For the purposes of measuring locations of features or parts relative to the throat 152, the measurement may be taken from anywhere within the nozzle flowpath 148 defining the throat 152. Notably, although the fuel injection port 162 is depicted as including two outlets 164 in radially adjacent arrangement, it should be understood that a plurality of fuel injection ports 162 may be distributed along the circumferential direction along the annulus of the nozzle 140.

The fuel provided through the fuel injection port 162 may be any suitable fuel, such as a hydrocarbon-based fuel, for mixing with the flow of oxidizer. More specifically, for the embodiment depicted the fuel injection port 162 is a liquid fuel injection port configured to provide a liquid fuel to the nozzle flowpath 148, such as a liquid jet fuel. However, in other exemplary embodiments, the fuel may be a gas fuel or any other suitable fuel.

Accordingly, for the embodiment depicted, positioning the fuel outlet 164 of the fuel injection port 162 in accordance with the description above may allow for the liquid fuel provided through the outlet 164 of the fuel injection port 162 to substantially completely atomize within the flow of oxidizer provided through the nozzle inlet 144 of the nozzle 140. Such may provide for a more complete mixing of the fuel within the flow of oxidizer, providing for a more complete and stable combustion within the combustion chamber 122.

Furthermore, for the embodiment depicted, the fuel injection port 162 is integrated into the nozzle 140. More specifically, for the embodiment depicted, the fuel injection port 162 extends through, and may be at least partially defined by, or positioned within, an opening extending through the nozzle wall 150 of the nozzle 140. Additionally, for the embodiment, the fuel injection port 162 further includes a plurality of fuel injection ports 162, with each fuel injection port 162 defining an outlet 164. In various embodiments, the plurality of fuel injection ports 162, each defining the outlet 164, are arranged along the circumferential direction around the longitudinal centerline 116. The plurality of fuel injection ports 162 may be arranged in symmetric or asymmetric arrangement around the longitudinal centerline 116.

Each of the one or more fuel injection ports 162 may be fluidly connected to a fuel source, such as a fuel tank, through one or more fuel lines for supplying the fuel to the fuel injection ports 162 (not shown). Additionally, it should be appreciated, that in other exemplary embodiments, the fuel injection port 162 may not be integrated into the nozzle 140. With such an exemplary embodiment, the RDC system 100 may instead include a fuel injection port having a separate structure extending, e.g., through the nozzle inlet 144 and nozzle flowpath 148. Such a fuel injection port may further define a fuel outlet positioned in the nozzle flowpath 148 between the nozzle inlet 144 and the nozzle outlet 146 for providing fuel to the flow of oxidizer received through the nozzle inlet 144.

A nozzle 140 in accordance with one or more of the exemplary embodiments described herein may allow for a relatively low pressure drop from the nozzle inlet 144 to the nozzle outlet 146 and into the combustion chamber 122. For example, in certain exemplary embodiments, a nozzle 140 in accordance with one or more of the exemplary embodiments described herein may provide for a pressure drop of less than about twenty percent. For example, in certain exemplary embodiments the nozzle 140 may provide for a pressure drop less than about twenty-five percent, such as between about one percent and about fifteen percent, such as between about one percent and about ten percent, such as between about one percent and about eight percent, such as between about one percent and about six percent. It should be appreciated, that as used herein, the term “pressure drop” refers to a pressure difference between a flow at the nozzle outlet 146 and at the nozzle inlet 144, as a percentage of the pressure of the flow at the nozzle inlet 144. Notably, including a nozzle 140 having such a relatively low pressure drop may generally provide for a more efficient RDC system 100. In addition, inclusion of a nozzle 140 having a converging-diverging configuration as is depicted and/or described herein may prevent or greatly reduce a possibility of the high pressure fluid (e.g., combustion products) within the region 134 behind the detonation wave 130 from flowing in an upstream direction, i.e., into the incoming fuel/air mixture flow 132 (see FIG. 3).

Referring back to FIG. 2, and now also to FIG. 11, it will be appreciated that for the embodiment described herein, the nozzle 140 is configured as one of the plurality of nozzles 140 arranged in an array extending along the circumferential direction C of the RDC system 100. Referring particularly to FIG. 11, a view of the RDC system 100 at a forward end/upstream end is provided along the longitudinal centerline 116 of the RDC system 100.

More specifically, for the embodiment depicted, the plurality of nozzles 140 of the RDC system 100 includes multiple arrays of nozzles 140 spaced along the radial direction R of the RDC system 100. Particularly for the embodiment of FIG. 11, the plurality of nozzles 140 of the RDC system 100 includes a first array 166 of nozzles 140, a second array 168 of nozzles 140, and a third array 170 of nozzles 140, each array extending along the circumferential direction C of the RDC system 100, i.e., including a plurality of nozzles 140 arranged along the circumferential direction C of the RDC system 100. For the embodiment depicted, the third array 170 of nozzles 140 is located outward of the second array 168 of nozzles 140 along the radial direction R, and the second array 168 of nozzles 140 is located outward of the first array 166 of nozzles 140 along the radial direction R.

Although for the embodiment depicted, the RDC system 100 includes three arrays of nozzles 140 spaced along the radial direction R, in other exemplary embodiments the RDC system 100 may instead include any other suitable number of arrays of nozzles 140, such as one array, two arrays, four arrays, and, e.g., up to about twenty arrays. Further, although for the embodiment depicted each array includes the same number of nozzles 140, in other exemplary embodiments, the arrays may vary the number of nozzles 140. With one or more of the above configurations, the plurality of nozzles 140 of the RDC system 100 may include a relatively high number of nozzles 140. For example, in certain embodiments, the plurality of nozzles 140 may include at least fifty nozzles 140 and up to, e.g., 10,000 nozzles 140. For example, in certain embodiments, the plurality of nozzles 140 may include between about seventy-five nozzles 140 and about five hundred nozzles 140, such as between about one hundred nozzles 140 and about three hundred and fifty nozzles 140. Additionally, although the nozzles 140 of each array is arranged along the radial direction (i.e., each nozzle 140 has the same circumferential position as a corresponding nozzle 140 in a radially inward or outward array of nozzles 140), in other embodiments, the nozzles 140 of one array may be staggered relative to the nozzles 140 of a radially inward array and/or a radially outward array.

Moreover, in certain embodiments, each nozzle 140 in the plurality of nozzles 140 may be configured in accordance with one or more of the embodiments described above with reference to FIG. 4. Further, in certain embodiments, each nozzle 140 in the plurality of nozzles 140 may be configured in substantially the same manner, or alternatively, in other embodiments, one or more of the plurality of nozzles 140 may include a varied geometry. Furthermore, although each of the plurality of nozzles 140 is depicted as including a substantially circular nozzle inlet 144 (and a substantially circular nozzle flowpath 148 along the respective lengthwise directions 142), in other embodiments, one or more of the plurality of nozzles 140 instead define any other suitable cross-sectional shape along a respective lengthwise direction 142, such as an ovular shape, a polygonal shape, etc. Similarly, although the converging and diverging sections 159, 161 are depicted as conical, in other exemplary embodiments, one or both of the sections 159, 161 may be defined by curved walls, or any other suitable shape. Additionally, the throat 152 of the nozzle 140 may be a single point along the longitudinal direction L, as opposed to an elongated cylindrical section.

Referring back to FIG. 2, and now also to FIG. 12, it will be appreciated that for the embodiment described herein, the nozzle 140 is configured as one of the plurality of nozzles 140 arranged in adjacent arrangement along the radial direction R. More specifically, for the embodiment depicted in FIG. 12, the plurality of nozzles 140 defines a plurality of throats 152 arranged in adjacent arrangement along the radial direction R and generally concentric around the longitudinal centerline 116 of the RDC system 100 and the propulsion system 102. Referring still to FIG. 12, and as shown and described in regard to FIGS. 2 and 4, the plurality of nozzles 140 are defined between the annular outer wall 118, the annular inner wall 120, and one or more annular intermediate walls 119 disposed between the outer wall 118 and the inner wall 120 along the radial direction R. In various embodiments, the plurality of nozzles 140 defined between each combination of the outer wall 118, the inner wall 120, and one or more of the intermediate walls 119 may be disposed in staggered arrangement along the radial direction R such that each nozzle 140 is disposed to a different location along the longitudinal direction. For example, each of the plurality of nozzles 140 defined separately within the outer wall 118 and the intermediate wall 119, one or more of the intermediate walls 119, and the intermediate wall 119 and the inner wall 120 may each be disposed upstream or downstream relative to one another.

In the embodiment shown in FIG. 12, the RDC 100 may further include one or more struts 195 extended generally along the radial direction R and coupled to the outer wall 118, the inner wall 120, and the one or more intermediate walls 119 therebetween. In one embodiment, the strut 195 defines an internal passage 176 configured in fluid communication with the fuel injection port 162 (shown in FIGS. 2 and 4), in which the internal passage 176 provides a fluid to the fuel injection port 162. The fluid may generally be a fuel as described herein. In another embodiment, the strut 195 defines a plurality of the internal passage 176 each configured in independent fluid communication with each nozzle 140. In various embodiments, the fluid may further be air or an inert gas, such as a purge fluid, to remove a fuel from the internal passage 176 and the fuel injection port 162, or to provide an effervescent flow of the fuel.

In various embodiments, the strut 195 extends along the longitudinal direction for approximately the length of the nozzle 140 or less. In one embodiment, the strut 195 defines an aerodynamic airfoil across which a flow of the oxidizer passes. In various embodiments, the strut 195 defines the airfoil to induce a bulk swirl of the oxidizer, such as a circumferential or tangential flow component along relative to the longitudinal centerline 116. The strut 195 may extend aft or downstream of the throat 152 to induce a bulk swirl on a mixture of the fuel and oxidizer. For example, the strut 195 may extend at an angle along the circumferential direction relative to the longitudinal centerline 116.

Although for the embodiment depicted, the RDC system 100 includes three arrays of nozzles 140 spaced along the radial direction R, in other exemplary embodiments the RDC system 100 may instead include any other suitable number of arrays of nozzles 140, such as one array (i.e., defined by the outer wall 118 and the inner wall 120), two arrays (i.e., defined by the outer wall 118, the inner wall 120, and an intermediate wall 119), four arrays or more (i.e., defined by the outer wall 118, the inner wall 120, and a plurality of intermediate walls 119 therebetween).

Moreover, in certain embodiments, each nozzle 140 in the plurality of nozzles 140 may be configured in accordance with one or more of the embodiments described above with reference to FIG. 4. Further, in certain embodiments, each nozzle 140 in the plurality of nozzles 140 may be configured in substantially the same manner, or alternatively, in other embodiments, one or more of the plurality of nozzles 140 may include a varied geometry. For example, the nozzle wall 150 of each nozzle 140 may define varied converging-diverging geometries, such as varying angles relative to the longitudinal centerline 116. In still other embodiments, the fuel injection port 162 of each nozzle 140 may define various areas, volumes, flowpaths, or other flow characteristics relative to each nozzle 140, or relative to various circumferential locations within each nozzle 140. In yet other embodiments, the nozzles 140 may be evenly spaced from one another between the outer wall 118 and the inner wall 120. In other embodiments, the nozzles 140 may be disposed in uneven arrangement such that one nozzle 140 defines a larger or smaller throat 152 than another nozzle 140, or one nozzle 140 is disposed closer to the outer wall 118 than the inner wall 120, etc.

In still other embodiments, the intermediate wall 119 may extend to or toward the combustion outlet 126 to define a plurality of generally separate combustion chambers 122 defining a plurality of different or various cross sectional areas or volumes. The plurality of various cross sectional areas or volumes of the plurality of combustion chambers 122 or nozzles 140 may be configured to produce a detonation cell height specific to one or more propulsion system 102 operating conditions. For example, the nozzle 140 may define a volume or cross sectional area configured to produce a detonation cell height within the combustion chamber 122 enhanced for idle engine operation (e.g., a lowest steady state operating speed or power output of the propulsion system 102). As another example, another nozzle 140 may define a volume or cross sectional area configured to produce a detonation cell height within the combustion chamber 122 enhanced for take-off operation (e.g., a highest steady state operating speed or power output of the propulsion system 102). As yet another example, the yet another nozzle 140 may define a volume or cross sectional area configured to produce a detonation cell height within the combustion chamber 122 enhanced for cruise operation of the propulsion system 102 (e.g., one or more steady state operating speeds or power outputs greater than idle and less than take-off). As such, each nozzle 140 may define different volumes or cross sectional areas configured more specifically to produce a cell height for a specific power output of the propulsion system 102. It should be appreciated that idle, cruise, or take-off operating conditions may include comparable operating conditions of various configurations of propulsion systems generally defining a low power, one or more intermediate power, or high power operations. The various embodiments of the RDC system 100 provided herein may provide low pressure drop operation while improving combustion stability, performance, and overall propulsion system operability across a plurality of operating conditions. For example, various embodiments, and combinations thereof, of the plurality of annular throats defined by combinations of the outer wall 118, one or more of the intermediate wall 119, and the inner wall 120; axial staggering of the plurality of nozzles 140 defined therein; and radial staggering of volumes, areas, or angles of each nozzle 140 defined therein may enable defining each nozzle 140 and the one or more combustion chambers 122 to improve combustion stability, efficiency, emissions, and overall propulsion system operability and performance across a plurality of operating conditions, such as ignition and ground idle, take-off, climb, cruise, approach, or various other low, intermediate, or high power conditions depending on propulsion system apparatus.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotating detonation combustion system for a propulsion system, the rotating detonation combustion system defining a radial direction, a circumferential direction, and a longitudinal centerline in common with the propulsion system extended along a longitudinal direction, the rotating detonation combustion system comprising:
an outer wall and an inner wall together defining at least in part a combustion chamber and a combustion chamber inlet;
a nozzle located at the combustion chamber inlet defined by a nozzle wall, the nozzle defining a lengthwise direction and extending between a nozzle inlet and a nozzle outlet along the lengthwise direction, the nozzle inlet configured to receive a flow of oxidizer, the nozzle further defining a throat between the nozzle inlet and nozzle outlet, and wherein the nozzle defines a converging-diverging nozzle, and wherein a diverging section of the nozzle wall defines a fluid diode; and
a fuel injection port defining a fuel outlet located between the nozzle inlet and the nozzle outlet for providing fuel to the flow of oxidizer received through the nozzle inlet.

2. The rotating detonation combustion system of claim 1, wherein the fluid diode defines a waveform configured to dampen upstream propagation of pressure waves from detonation of a fuel-oxidizer mixture.

3. The rotating detonation combustion system of claim 2, wherein the waveform is a sawtooth waveform, a square waveform, a triangle waveform, a sine waveform, or combinations thereof.

4. The rotating detonation combustion system of claim 3, wherein the waveform is a sawtooth waveform, a triangle waveform, or combinations thereof, and wherein the waveform defines a waveform angle, and wherein the waveform angle extends between approximately zero degrees and approximately 90 degrees relative to the longitudinal centerline.

5. The rotating detonation combustion system of claim 4, wherein the waveform angle extends between approximately 45 degrees and approximately 90 degrees relative to the longitudinal centerline.

6. The rotating detonation combustion system of claim 1, wherein the fluid diode defines a honeycomb pattern.

7. The rotating detonation combustion system of claim 1, wherein the fluid diode is asymmetric along at least one of the outer wall and the inner wall along the longitudinal direction.

8. The rotating detonation combustion system of claim 1, wherein a converging section of at least one of the outer wall and the inner wall of the nozzle defines a fluid diode.

9. The rotating detonation combustion system of claim 8, wherein the waveform is a sawtooth waveform, a triangle waveform, or combinations thereof, and wherein the waveform defines a waveform angle, and wherein the waveform angle extends between approximately zero degrees and approximately 90 degrees relative to the longitudinal centerline.

10. The rotating detonation combustion system of claim 1, wherein the diverging section of the nozzle is defined on the outer wall and the inner wall between the throat and the nozzle outlet of the nozzle, and wherein one or more of the outer wall and the inner wall defines the fluid diode.

11. The rotating detonation combustion system of claim 1, wherein a converging section is defined on the nozzle wall between the nozzle inlet and the throat of the nozzle, and wherein the fluid diode is defined on the converging section of the nozzle wall.

12. The rotating detonation combustion system of claim 1, wherein the nozzle is configured as one of a plurality of nozzles arranged in an array along the circumferential direction.

13. The rotating detonation combustion system of claim 12, wherein the plurality of nozzles includes a plurality of arrays of nozzles disposed in adjacent arrangement along the radial direction, in which each array is configured to at least one operating condition of the propulsion system.

14. The rotating detonation combustion system of claim 1, wherein the outer wall and the inner wall are annular and are each generally concentric to the longitudinal centerline, and wherein the outer wall and the inner wall together define the nozzle wall as an annular structure concentric to the longitudinal centerline.

15. The rotating detonation combustion system of claim 14, wherein the fluid diode is asymmetric along at least one of the outer wall and the inner wall along the circumferential direction.

16. The rotating detonation combustion system of claim 14, further comprising:
an annular intermediate wall disposed along the radial direction between the outer wall and the inner wall and generally concentric to the longitudinal centerline, wherein the outer wall, the intermediate wall, and the inner wall together define a plurality of annular nozzles generally concentric to the longitudinal centerline, and wherein each nozzle defines the throat between the nozzle inlet and the nozzle outlet.

17. The rotating detonation combustion system of claim 16, wherein the annular intermediate wall at least partially defines a diverging section of the nozzle, and wherein the diverging section defines a fluid diode.

18. The rotating detonation combustion system of claim 14, wherein the plurality of annular nozzles are disposed in adjacent arrangement along the radial direction and generally concentric to the longitudinal centerline.

19. The rotating detonation combustion system of claim 1, wherein the nozzle defines a nozzle length, wherein the fuel outlet of the fuel injection port is positioned at the throat of the nozzle or within a buffer distance from the throat of the nozzle along the lengthwise direction, wherein the buffer distance is ten percent of the nozzle length.

20. The rotating detonation combustion system of claim 19, wherein the fluid diode is defined at least downstream of the buffer distance.
